(19) United States
(12) Patent Application Publication
(10) Pub. No.: US 2018/0136490 A1
(43) Pub. Date: May 17, 2018

(54) TINT-ADJUSTING SUNGLASSES

(71) Applicant: Ho Jun Yang, New York, NY (US)

(72) Inventor: Ho Jun Yang, New York, NY (US)

(21) Appl. No.: 15/811,593

(22) Filed: Nov. 13, 2017

Related U.S. Application Data
(60) Provisional application No. 62/421,996, filed on Nov. 14, 2016.

(51) Int. Cl. G02C 7/10

(52) U.S. Cl. CPC G02C 7/101; G02C 7/10

(57) ABSTRACT

Tint-adjusting sunglasses are provided that in some embodiments may comprise a sunglasses-shaped housing having at least one arm, a lens-containing frame, at least one tint-adjusting lens having an amount of transparency disposed within the lens-containing frame, at least one tint-adjusting controller, and at least one communicative element disposed on the at least one arm, wherein the communicative element is connected to the tint-adjusting controller and the tint-adjusting lens. In some embodiments, an adjustment of the tint-adjustment controller causes a change in the communicative element that causes a change in the transparency of the at least one tint-adjusting lens. In some embodiments, the tint-adjusting controller may be configured to adjust by sliding.

### CROSS-REFERENCE TO RELATED APPLICATION

This application claims priority to U.S. Provisional Application No. 62/421,996 filed on Nov. 14, 2016, the disclosure of which, including any materials incorporated by reference therein, is incorporated herein by reference in its entirety.

### TECHNICAL FIELD

The present invention relates generally to the field of sunglasses and more specifically relates to sunglasses that are configured to allow a user to manually adjust the level of tinting.

### BACKGROUND

Sunglasses are a great fashion accessory, but their most important job is to protect users' eyes from the sun's ultraviolet (UV) rays. Some of the sun's detrimental effects on the eyes include cataracts, macular degeneration, and pterygium, which can cause astigmatism. Most consumers have been educated about the need to wear sunglasses to protect the health of their eyes, but there are times when wearing tinted sunglasses is not the best idea. Sunglasses with a dark tint are needed when the sun is shining brightly during the day, but it is not advisable to wear darkly tinted sunglasses late in the day, as certain objects may not be visible as the darkness encroaches.

Therefore, a need exists for a specially designed way to adjust the tint of the sunglasses manually, and users will be able to change the amount of tint depending on the current conditions. This ensures their eyes will always be protected by wearing sunglasses, but their vision will never be diminished by wearing sunglasses which are too dark.

Various attempts to solve this problem have been made. One such attempt can be seen with respect to U.S. Patent Application Publication No. 2009/0027759, incorporated by reference in its entirety herein, which generally discloses a glass tint-adjusting system wherein particles within the glass are activated to transform and cause the glass to be tinted when stimulated by light-sensing electrodes. While this disclosure does provide for glass wherein the darkness of the tint is precisely matched to the current sunlight conditions, this disclosure relies on complicated sensors and elaborate compositions of suspended particles and window surface treatments. Additionally, the glass contemplated by this disclosure is inappropriate for sunglasses.

Another attempt can be seen with respect to U.S. Pat. No. 5,114,218, incorporated by reference in its entirety herein, which generally discloses a sunglasses device wherein a user can electronically control liquid crystal lenses and change them from one color to another. While this disclosure does provide for sunglasses having adjustable tint, its color-based choices fail to provide for the aesthetic and functionality provided herein. Nor does this disclosure provide for a primarily manual adjustment mechanism.

Yet another attempt can be seen with respect to U.S. Pat. No. 6,420,036, incorporated by reference in its entirety herein, which generally discloses electrochromic polymer films, wherein the film utilizes an electrochromic medium to filter light as it passes through the medium. While this disclosure does provide for a sophisticated chemical answer to the problem of adjustable tinted glass, it requires two glass substrates and various layers to work, therefore increasing its cost to both install and repair, and would be inappropriate for sunglasses lenses as disclosed.

Various attempts have been made to solve the problems which may be found in the related art but have thus far been unsuccessful. A need exists for sunglasses having adjustable tint lenses to avoid the above-mentioned problems.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as lenses, support, arm, etc., are herein meant to include or encompass all equivalents for such elements. For example, in addition to a “sunglasses lens”, any transparent or semi-transparent object is contemplated. Such equivalents are contemplated for each element named in its particular herein.

The present invention relates to tint-adjusting sunglasses that overcomes the deficiencies of the prior art. It is contemplated that the present invention may provide a pair of sunglasses that allows a user to manually adjust the level of tint in the sunglasses' lenses. By way of illustration and not limitation, in some embodiments, sliding a slider-configured adjustment mechanism forward may increase the level of tint, while sliding the slider-configured adjustment mechanism backwards may reduce the level of tint.

More specifically, the present invention may provide for tint-adjusting sunglasses comprising a sunglasses-shaped housing having at least one arm and at least one lens-containing frame, as well as at least one tint-adjusting lens having an amount of transparency disposed within the lens-containing frame. In some embodiments, the present invention may further comprise at least one communicative element disposed on or along the at least one arm and the at least one lens-containing frame, as well as at least one tint-adjustment controller disposed on the outside of the at least one arm. In some embodiments, the at least one tint-adjustment controller may be mechanically or electrically coupled to the at least one at least one tint-adjusting lens, such that when the at least one tint-adjustment controller is repositioned, the at least one tint-adjustment controller causes a change in the at least one communicative element, which in turn causes a change in the amount of transparency in the at least one tint-adjusting lens.

In some embodiments, the tint-adjusting lens may have two or more mechanically positionable lenses. For example, as more fully explained below, the tint-adjusting lens may comprise two or more lenses stacked or positioned on top of one another wherein one or more of the stacked lenses can be repositioned, causing a change in the overall transparency of the tint-adjusting lens, making it more or less transparent and hence a “lighter” or “darker” tinted lens. In such embodiments, the change in the amount of transparency in the tint-adjusting lens may be caused by a change in position of the at least one tint-adjustment controller that causes a change in configuration or position of the at least one communicative element, which may mechanically or electrically carry the change to the mechanically positionable at least one tint-adjusting lens, causing one or more of the stacked (or any equivalent term used herein) lenses to change position and hence change the transparency of the at least one lens.

Similarly, in some embodiments, the at least one tint-adjusting lens may have at least one chemically-modifiable layer on top of an otherwise unmodified lens, wherein the at least one chemically-modifiable layer comprises at least one reconfigurable element, wherein the at least one reconfigurable element is capable of at least two positions, and wherein each of the at least two positions have different transparencies. In such embodiments, the change in the amount of transparency in the tint-adjusting lens may be caused by a change in position of the at least one tint-adjustment controller that causes a change in configuration or position of the at least one reconfigurable element, causing a change the transparency of the at least one lens.

In other embodiments, rather than only one chemically-modifiable layer, the tint-adjusting lens may comprise two or more chemically modifiable or changeably layers stacked or positioned on top of one another (if applicable) wherein one or more reconfigurable elements within one or more of the stacked “chemical” lenses (such as by way of illustration and not limitation a compound) can be chemically or electrically caused to reconfigure itself, such as between different energy levels or in different spatial orientations, causing a change in the overall transparency of the tint-adjusting lens, making it more or less transparent and hence a “lighter” or “darker” tinted lens. In such embodiments, the change in the amount of transparency in the tint-adjusting lens may be caused by a change in position of the at least one tint-adjustment controller that causes a change in configuration or position of the at least one communicative element, which may mechanically or electrically carry the change to the at least one reconfigurable element, causing one or more of the at least one reconfigurable element to change position and hence change the transparency of the at least one lens.

In some embodiments, the at least one tint-adjustment controller may be slideably connected to the at least one arm. In slidably-connected embodiments, it is contemplated that the at least one tint-adjustment controller may cause a change in the transparency of the at least one tint-adjusting lens when the at least one tint-adjustment controller is caused to slide from one position to another.

In some embodiments, the housing may be designed to accommodate a single lens design wherein the at least one tint-adjusting lens is one tint-adjusting lens shaped to cover two eyes. In some embodiments (as discussed herein) the housing may be shaped to accommodate a two-lens design, wherein each tint-adjusting lens is shaped to cover one eye. In other embodiments (also discussed herein), the housing may be shaped to accommodate a single lens design wherein the at least one tint-adjusting lens is one tint-adjusting lens shaped to cover one eye.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel pair of tint-adjusting sunglasses. The general purpose of the present invention, which will be described subsequently in greater detail, is to provide a pair of sunglasses that a user can manually adjust with just one finger to increase or decrease the level of tint in the sunglasses' lenses. The features of the invention which are believed to be novel are particularly pointed out and distinctly claimed in the concluding portion of the specification. These and other features, aspects, and advantages of the present invention will become better understood with reference to the following drawings and detailed description.

In one embodiment, the present invention may provide for a pair of sunglasses that provide a built-in slider mechanism on an arm of the sunglasses that, when adjusted, manually adjusts the present invention's tint-adjusting lenses. Based on the adjustments, the lenses of the present invention may change their orientations so as to allow more or less light to pass though the lenses, and may change the trajectory, wavelength, or other properties of the light as well. Any shape sunglasses, lenses, or tint-adjustment controller is contemplated.

It is contemplated that the unique features of this product may provide one or more benefits to one or more users. For example, the present invention may provide an easy and convenient way to adjust the level of tint in sunglasses manually. It may also allow users to control the level of tint freely and accurately, thereby optimizing their ability to see as conditions change. The present invention's tint levels may be adjusted easily, without needing batteries or an app on one's smart phone, which makes the present invention very user-friendly for individuals of all ages. It may enable users to enjoy dark tinted lenses when the sun is shining brightly, and less tinted lenses when looking at the scenery, and in the early morning and late afternoons, when more light is needed to see obstacles clearly. It may eliminate the need to own and carry different pairs of sunglasses with various degrees of tint that require users to change them depending on the current conditions.

### BRIEF DESCRIPTION OF THE DRAWINGS

These and other features, aspects and advantages of the present invention will become better understood with regard to the following description, appended claims, and accompanying figures where:

FIG. 1 shows a front perspective view of a pair of tint-adjusting sunglasses in accordance with an embodiment of the invention.

FIG. 2 shows a front perspective view of a pair of tint-adjusting sunglasses in accordance with an embodiment of the invention.

FIG. 3 shows a front perspective view of a pair of tint-adjusting sunglasses in accordance with an embodiment of the invention.

FIG. 4 shows a top front perspective view of a pair of tint-adjusting sunglasses in accordance with one embodiment of the invention.

FIG. 5 shows a top front perspective view of a pair of tint-adjusting sunglasses in accordance with one embodiment of the invention.

FIG. 6 shows a top front perspective view of a pair of tint-adjusting sunglasses in accordance with one embodiment of the invention.

### DETAILED DESCRIPTION

The present invention overcomes the limitations of the prior art by providing a new and more effective pair of tint-adjusting sunglasses.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

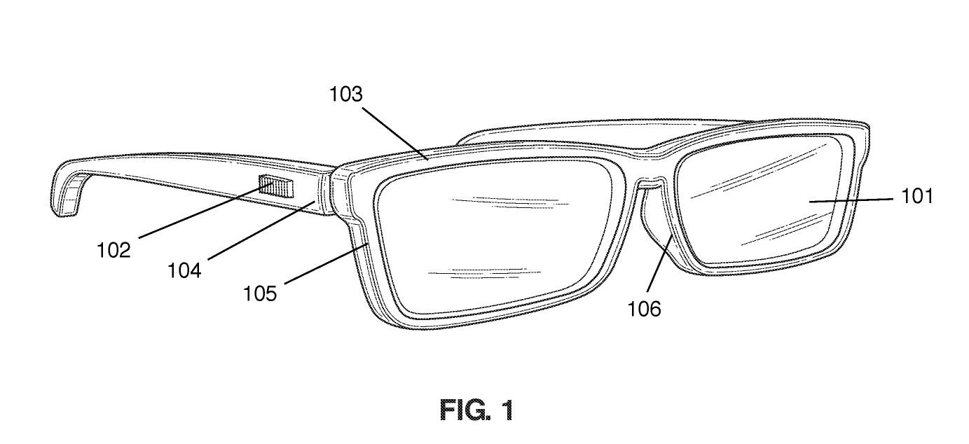

With respect to FIG. 1, a front perspective view of a pair of tint-adjusting sunglasses in accordance with an embodiment of the invention is shown. In the embodiment depicted, a viewer may perceive tint-changing lenses 101, tint adjustment controller 102, housing upper portion 103, arm 104, housing lower portion 105, and housing nose bridge 106.

In the embodiment depicted in FIG. 1, tint changing lenses 101 are shown in their “light” or more transparent state. Tint adjustment controller 102 is shown in a corresponding position.

In some embodiments, the present invention may provide for two or more tint changing lenses 101 that may cover two eyes. In some embodiments having a two-lens design, each lens may be a tint changing lens 101. In other two-lens embodiments, only one lens may be a tint changing lens 101. In some embodiments, part but not all of tint changing lens 101 may be configured to change transparency.

Some two-lens designs may have a separated housing upper portion 103, wherein each housing upper portion 103 is joined by a wire or other connection element. In some embodiments, housing nose bridge 106 may be suspended from this connecting element.

It is contemplated that any of several tint changing lens 101 may be provided. In some embodiments, tint changing lens 101 may be comprised of one or more lenses (not pictured) layered or arranged in sequence. In such embodiments, the present invention may provide that tint adjustment controller 102 may be connected to an adjustment element (not shown) that, when tint adjustment controller 102 is manipulated, may cause the layers or lenses of tint changing lens 101 to change their orientation. In some embodiments, when the elements of tint changing lens 101 change their orientation, it may cause the light passing through tint changing lens 101 to be altered or redirected such that more or less light, or more or less concentrated light, may pass through tint changing lens 101 and presumably into the user's eye(s). Other orientation-based light-changing elements or mechanisms may be incorporated within tint changing lens 101, including any known in the art.

In some embodiments, tint changing lens 101 may be comprised of a single lens that has one or more electrical or chemical tint-changing elements. In some such embodiments, tint changing lens 101 may have one or more layers comprising an organic or inorganic substance that may change its light permeability in response to an electric current. Other conceivable configurations might be a single layer having granular or moveable elements, such that when tint changing lens 101 are shaken, such particles or elements disperse to cover more area of tint changing lens 101, and thereby blocking out more light, and then the particles or elements settle and the light permeability of tint changing lens 101 may return to normal. Other chemistry-based or materials-based light-changing elements or mechanisms may be incorporated within tint changing lens 101, including any known in the art.

As discussed above, tint adjustment controller 402 may vary in each embodiment. In configurations utilizing primarily or exclusively mechanical adjustment means, tint adjustment controller 102 may be a slider that slides from one setting to another, thereby changing the orientation or configuration of tint changing lens 101 correspondingly. For example, in a slider configuration, sliding tint adjustment controller 102 towards tint changing lens 101 may cause one or more transition elements (not shown) within or on housing upper portion 103, arm 104, housing lower portion 105, and/or housing nose bridge 106 to twist, extend, contract, or otherwise change their orientation. The changes in orientation of these one or more transition elements may cause tint changing lens 101 to change orientation as well, and hence make the lenses lighter or darker. In electrical embodiments, sliding tint adjustment controller 102 may carry a signal through a wire (not shown) to an electrical transition element (not shown) that may interpret or pass along the signal to tint adjustment controller 102, whereupon the signal may cause tint adjustment controller 102 to change its orientation or configuration and hence make tint changing lens 101 lighter or darker.

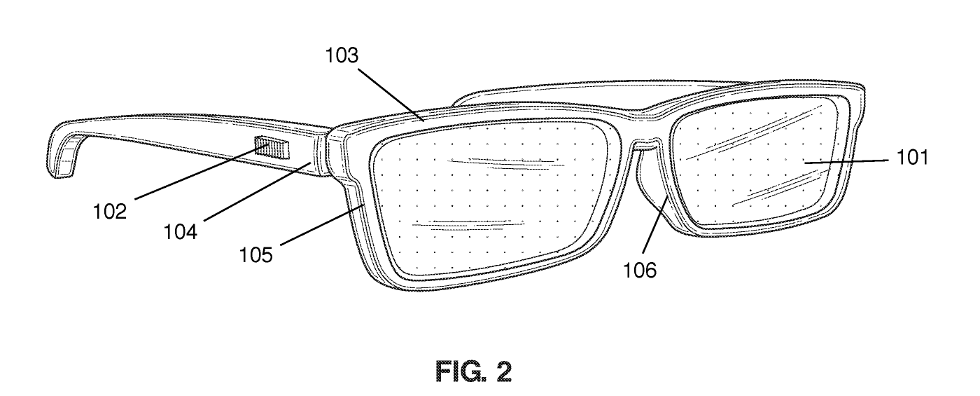

Turning attention to FIG. 2, a front perspective view of a pair of tint-adjusting sunglasses in accordance with an embodiment of the invention is shown. In the embodiment depicted, a viewer may perceive tint-changing lenses 101, tint adjustment controller 102, housing upper portion 103, arm 104, housing lower portion 105, and housing nose bridge 106.

In the embodiment depicted in FIG. 2, tint changing lenses 101 are shown in their “medium” or medium-level transparency state. Tint adjustment controller 102 is shown in a corresponding position.

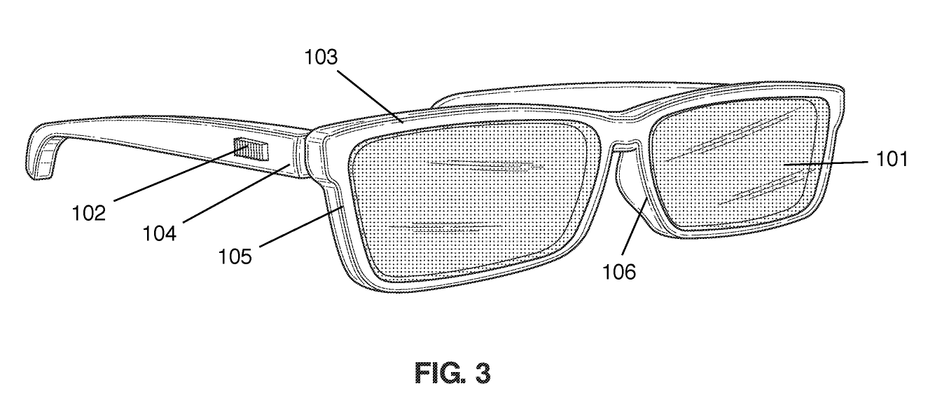

With respect to FIG. 3, a front perspective view of a pair of tint-adjusting sunglasses in accordance with an embodiment of the invention is shown. In the embodiment depicted, a viewer may perceive tint-changing lenses 101, tint adjustment controller 102, housing upper portion 103, arm 104, housing lower portion 105, and housing nose bridge 106.

In the embodiment depicted in FIG. 3, tint changing lenses 101 are shown in their “dark” or least transparent state. Tint adjustment controller 102 is shown in a corresponding position.

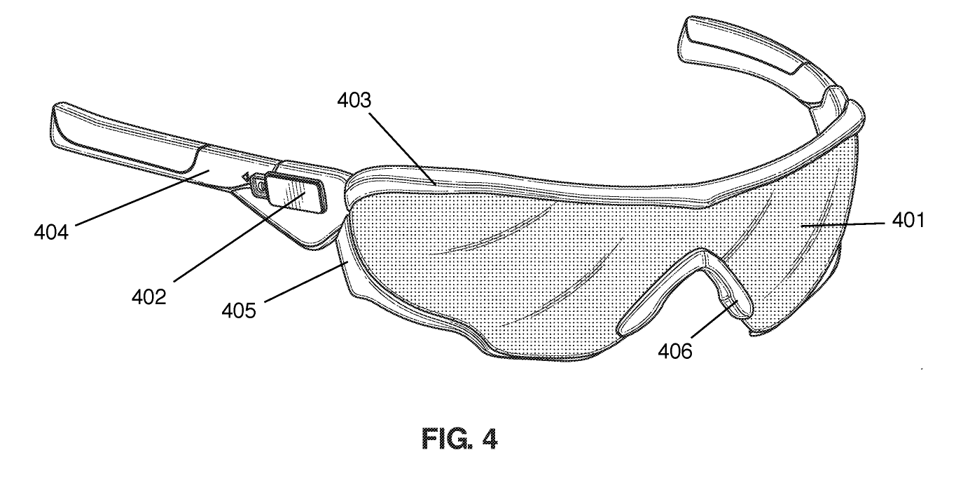

Turning attention to FIG. 4, a front perspective view of a pair of tint-adjusting sunglasses in accordance with an embodiment of the invention is shown. In the embodiment depicted, a viewer may perceive single-lens design tint changing lenses 401, single-lens design tint adjustment controller 402, single-lens design upper support 403, single-lens design arm 404, single-lens design lower support 405, and single-lens design center support 406.

In the embodiment depicted in FIG. 4, single-lens design tint changing lenses 401 are shown in their “dark” or least transparent state. Single-lens design tint adjustment controller 402 is shown in a corresponding position. In some embodiments, part but not all of single-lens design tint changing lenses 401 may be configured to change transparency.

In some embodiments, as shown in FIG. 4, single-lens design tint changing lenses 401 may comprise a single or unitary lens that covers both of a user's eyes. In other embodiments wherein the present invention is only intended to cover or affect one eye, such as but not limited to a telescope or monocle, the present invention may provide for one single-lens design tint changing lenses 401 that is configured to cover one eye.

It is contemplated that any of several single-lens design tint-changing lenses 401 may be used. In some embodiments, single-lens design tint changing lenses 401 may be comprised of one or more lenses (not pictured) layered or arranged in sequence. In such embodiments, the present invention may provide that single-lens design tint adjustment controller 402 may be connected to an adjustment element (not shown) that, when single-lens design tint adjustment controller 402 is manipulated, may cause the layers or lenses of single-lens design tint changing lenses 401 to change their orientation. In some embodiments, when the elements of single-lens design tint changing lenses 401 change their orientation, it may cause the light passing through single-lens design tint changing lenses 401 to be altered or redirected such that more or less light, or more or less concentrated light, may pass through single-lens design tint changing lenses 401 and presumably into the user's eye(s). Other orientation-based light-changing elements or mechanisms may be incorporated within single-lens design tint changing lenses 401, including any known in the art.

In some embodiments, single-lens design tint changing lenses 401 may be comprised of a single lens that has one or more electrical or chemical tint-changing elements. In some such embodiments, single-lens design tint changing lenses 401 may have one or more layers comprising an organic or inorganic substance that may change its light permeability in response to an electric current. Other conceivable configurations might be a single layer having granular or moveable elements, such that when single-lens design tint changing lenses 401 are shaken, such particles or elements disperse to cover more area of single-lens design tint changing lenses 401, and thereby blocking out more light, and then the particles or elements settle and the light permeability of single-lens design tint changing lenses 401 may return to normal. Other chemistry-based or materials-based light-changing elements or mechanisms may be incorporated within single-lens design tint changing lenses 401, including any known in the art.

As discussed above, single-lens design tint adjustment controller 402 may vary in each embodiment depending on the type of single-lens design tint changing lenses 401 provided. In configurations utilizing primarily or exclusively mechanical adjustment means, single-lens design tint adjustment controller 402 may be a slider that slides from one setting to another, thereby changing the orientation or configuration of single-lens design tint changing lenses 401 correspondingly. For example, in a slider configuration, sliding single-lens design tint adjustment controller 402 towards single-lens design tint changing lenses 401 may cause one or more transition elements (not shown) within or on single-lens design upper support 403, single-lens design arm 404, single-lens design lower support 405, and single-lens design center support 406 to twist, extend, contract, or otherwise change their orientation. The changes in orientation of these one or more transition elements may cause single-lens design tint changing lenses 401 change orientation as well, and hence make the lenses lighter or darker. In electrical embodiments, sliding (as appropriate to the design or configuration of the present invention) single-lens design tint adjustment controller 402 may carry a signal through a wire (not shown) to an electrical transition element (not shown) that may interpret or pass along the signal to single-lens design tint adjustment controller 402, whereupon the signal causes single-lens design tint adjustment controller 402 to change its orientation or configuration and hence make the lenses lighter or darker.

In the embodiment depicted in FIG. 4, the sunglasses surrounding single-lens design tint changing lenses 401 include single-lens design upper support 403, single-lens design arm 404, single-lens design lower support 405, and single-lens design center support 406. It is contemplated that the present invention may provide for any shape sunglasses and any shape single-lens design tint changing lenses 401. As such, single-lens design upper support 403, single-lens design arm 404, single-lens design lower support 405, and single-lens design center support 406 may change in shape, materials, and construction from embodiment to embodiment. It is contemplated that single-lens design upper support 403, single-lens design arm 404, single-lens design lower support 405, and single-lens design center support 406 may be different in some other shapes of sunglasses.

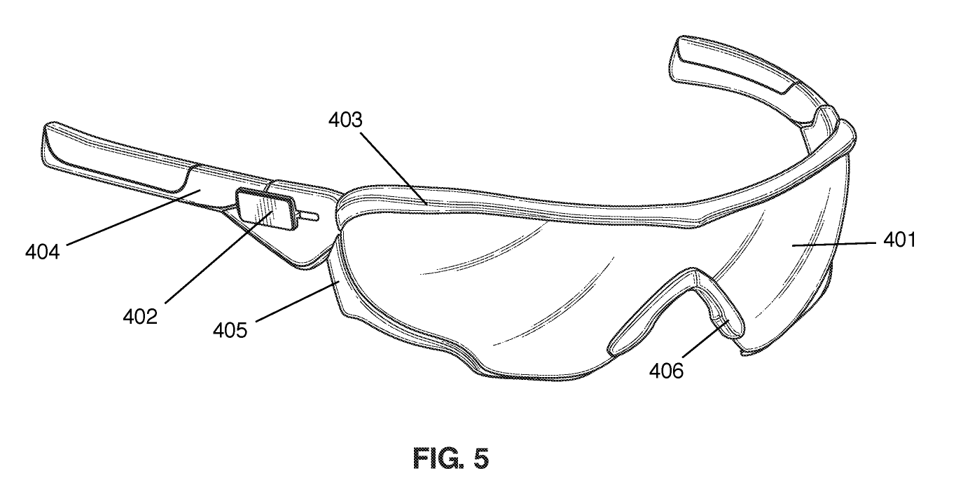

With respect to FIG. 5, a top front perspective view of a pair of tint-adjusting sunglasses in accordance with an embodiment of the invention is shown. In the embodiment depicted, a viewer may perceive single-lens design tint changing lenses 401, single-lens design tint adjustment controller 402, single-lens design upper support 403, single-lens design arm 404, single-lens design lower support 405, and single-lens design center support 406.

In the embodiment depicted in FIG. 5, single-lens design tint changing lenses 401 are shown in their “light” or most transparent state. Single-lens design tint adjustment controller 402 is shown in a corresponding position.

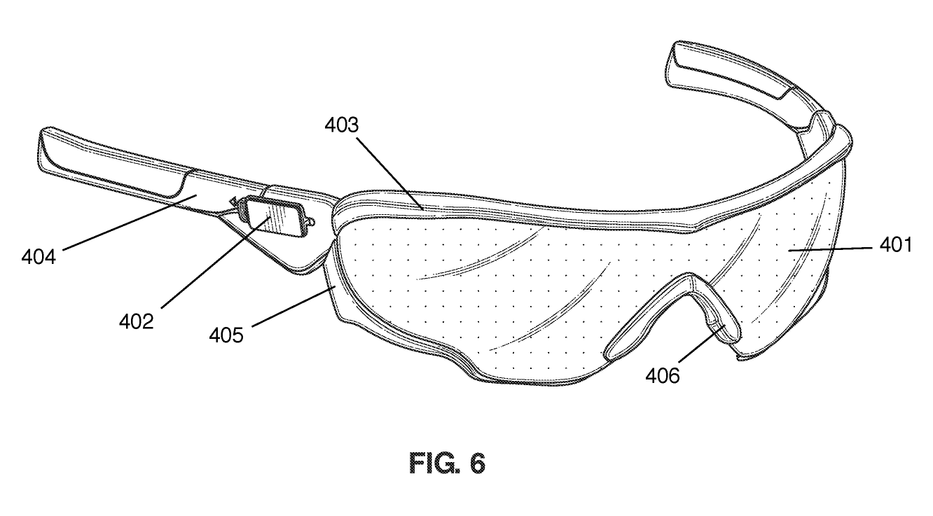

With respect to FIG. 6, a top perspective view of a pair of tint-adjusting sunglasses in accordance with an embodiment of the invention is shown. In the embodiment depicted, a viewer may perceive single-lens design tint changing lenses 401, single-lens design tint adjustment controller 402, single-lens design upper support 403, single-lens design arm 404, single-lens design lower support 405, and single-lens design center support 406.

In the embodiment depicted in FIG. 6, single-lens design tint changing lenses 401 are shown in their “medium” or medium transparency state. Single-lens design tint adjustment controller 402 is shown in a corresponding position.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the tint-adjusting sunglasses generally described herein has been disclosed in connection with a number of embodiments shown and described in detail, various modifications should be readily apparent to those of skill in the art.

What is claimed is:

1. Tint-adjusting sunglasses, comprising:
a sunglasses-shaped housing having at least one arm and at least one lens-containing frame;
at least one tint-adjusting lens having an amount of transparency, wherein the at least one tint-adjusting lens is disposed within the lens-containing frame;
at least one communicative element disposed along the at least one arm and the at least one lens-containing frame; and
at least one tint-adjustment controller disposed on the outside of at least one arm, wherein the at least one tint-adjustment controller is mechanically coupled to the at least one at least one tint-adjusting lens, and wherein the at least one tint-adjustment controller is configured such that when the at least one tint-adjustment controller is repositioned, the at least one tint-adjustment controller causes a change in the at least one communicative element, and wherein the change in the at least one communicative element causes a change in the amount of transparency in the at least one tint-adjusting lens.

2. The tint-adjusting sunglasses of claim 1, wherein the at least one tint-adjusting lens has two or more mechanically positionable lenses.

3. The tint-adjusting sunglasses of claim 2, wherein the at least one communicative element causes a change in the amount of transparency in the at least one tint-adjusting lens by causing a change of position in the two or more mechanically positionable lenses.

4. The tint-adjusting sunglasses of claim 1, wherein the at least one tint-adjusting lens has at least one chemically-modifiable layer, wherein the at least one chemically-modifiable layer has at least one reconfigurable element, wherein the at least one reconfigurable element is capable of at least two positions, and wherein each of the at least two positions have different transparencies.

5. The tint-adjusting sunglasses of claim 4, wherein the at least one communicative element causes a change in the amount of transparency in the at least one tint-adjusting lens by causing a change of position of one or more reconfigurable elements.

6. The tint-adjusting sunglasses of claim 1, at least one tint-adjustment controller is slideably connected to the at least one arm.

7. The tint-adjusting sunglasses of claim 1, wherein the housing is shaped to accommodate a single lens design.

8. The tint-adjusting sunglasses of claim 7, wherein the at least one tint-adjusting lens is one tint-adjusting lens shaped to cover two eyes.

9. The tint-adjusting sunglasses of claim 7, wherein the at least one tint-adjusting lens is one tint-adjusting lens shaped to cover one eye.

10. The tint-adjusting sunglasses of claim 1, wherein the housing is shaped to accommodate a two-lens design.

11. The tint-adjusting sunglasses of claim 10, wherein the at least one tint-adjusting lens is two tint-adjusting lenses.

12. The tint-adjusting sunglasses of claim 10, wherein one lens is a tint-adjusting lens and the other lens is an unmodified lens.

13. The tint-adjusting sunglasses of claim 1, wherein part of the at least one tint-adjusting lens, but not all of the at least one tint-adjusting lens, is configured to change transparency.
